(19) United States
(12) Patent Application Publication
(10) Pub. No.: US 2007/0189471 A1
(43) Pub. Date: Aug. 16, 2007

(54) Communication apparatus

(75) Inventor: Kazumasa Suzuki, Tokyo (JP)

Correspondence Address: BUCHANAN, INGERSOLL & ROONEY PC, POST OFFICE BOX 1404, ALEXANDRIA, VA, 22313-1404, US

(73) Assignee: Renesas Technology Corp., Tokyo (JP)

(21) Appl. No.: 11/653,386

(22) Filed: Jan. 16, 2007

(30) Foreign Application Priority Data
Jan. 16, 2006 (JP) 2006-7732

(51) Int. Cl. H04M 11/00

(52) U.S. Cl. 379/93.31

(57) ABSTRACT

If a signal-to-noise ratio determining unit determines that a ratio of a signal level to a noise level exceeds a threshold, and also if a preamble determining unit determines that logical data matches preamble data, a communication apparatus starts receiving a communication frame. In other words, the communication apparatus starts receiving the communication frame only after confirming existence of a carrier.

### BACKGROUND OF THE INVENTION

1. Field of the Invention

The present invention generally relates to a communication apparatus that performs asynchronous communication by using the same carrier frequency.

2. Description of the Related Art

The Carrier Sense Multiple Access with Collision Avoidance (CSMA/CA) is cited as a method of communicating asynchronously with a plurality of terminals by using the same carrier frequency.

In the CSMA/CA, when data is to be transmitted to a transmission channel, a state of the transmission channel is determined by a carrier sensing. Namely, whether a carrier exists on the transmission channel is detected to determine a state of the transmission channel. If a carrier is not detected within a predetermined time, the data can be transmitted to the transmission channel.

If a carrier is detected, the data is not transmitted until no carrier is detected. After a certain time (back off time) passes from when no carrier is detected, the data is transmitted to the transmission channel.

One of the carrier sense methods is to calculate a signal level on the transmission channel. If the signal level exceeds a threshold, it is determined that a carrier exists on the transmission channel.

However, when a signal level temporarily increases due to noise, even if there is no carrier on the transmission channel, the presence of a carrier is erroneously determined because the signal level exceeds the threshold.

As a result, the transmission of the data is interrupted. Thus, data throughput decreases because transmission of the data is resumed after the certain time.

Furthermore, if a terminal once initiates data reception due to the erroneous determination, it takes a predetermined time to complete the data reception. Even if necessary data is transmitted from another terminal, the terminal cannot receive the data during the predetermined time. Thus, data throughput decreases because the terminal receives the data that the other terminal retransmits next time.

Japanese Patent No. 3410890 discloses a communication apparatus that prevents an influence of noise. The communication apparatus, which does not employ the carrier sense method, calculates an average of signal levels of received frames. The average is compared with a signal level on a transmission channel. If a difference between the average and the signal level exceeds a threshold, the signal level on the transmission channel, which temporarily increases due to noise, is excluded from the average calculation. Thus, it is possible to avoid an influence of noise.

However, if the condition of the transmission channel is very bad, the noise level fluctuates remarkably depending on time and space. Therefore, it is not enough to compare each signal level on the transmission channel with a carrier level (the average of signal levels of the received frames). Under such a condition, it is difficult to accurately determine whether a carrier exists on the transmission channel. Thus, data throughput can decrease due to erroneous detection of a carrier.

### SUMMARY OF THE INVENTION

It is an object of the present invention to at least partially solve the problems in the conventional technology.

According to an aspect of the present invention, a communication apparatus includes a signal-level measuring unit that periodically measures a signal level of a communication signal on a transmission channel, a noise-level calculating unit that calculates, as a noise level, an average of signal levels measured by the signal-level measuring unit during a period in which no communication signal is communicated, a signal-to-noise ratio determining unit that calculates a ratio of each of the signal levels to the noise level to obtain a signal-to-noise ratio corresponding to each of the signal levels, and determines whether the signal-to-noise ratio exceeds a threshold, a preamble determining unit that demodulates the communication signal from the transmission channel into logical data, and determines whether the logical data matches preamble data, and a reception processing unit that starts receiving the communication signal when the signal-to-noise ratio exceeds the threshold, and the logical data matches the preamble data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a communication apparatus according to a first embodiment of the present invention;

FIG. 2 is a frame format of a communication signal (a communication frame) used by the communication apparatus shown in FIG. 1;

FIG. 3 is a flowchart of the operation of the communication apparatus shown in FIG. 1;

FIG. 4 is a schematic for explaining mutual communication between terminals A and B, each being the communication apparatus shown in FIG. 1;

FIG. 5 is a flowchart of the operation of a communication apparatus according to a second embodiment of the present invention;

FIG. 6 is a flowchart of the operation of a communication apparatus according to a third embodiment of the present invention;

FIG. 7 is a flowchart of the operation of a communication apparatus according to a fourth embodiment of the present invention;

FIG. 8 is a block diagram of a communication apparatus according to a fifth embodiment of the present invention;

FIG. 9 is a flowchart of the operation of the communication apparatus shown in FIG. 8;

FIG. 10 is a block diagram of a communication apparatus according to a sixth embodiment of the present invention;

FIG. 11 is a schematic for explaining a range of a phase difference between a current symbol and a previous symbol to determine whether a carrier exists; and

FIG. 12 is a flowchart of the operation of the communication apparatus shown in FIG. 10.

### DETAILED DESCRIPTION OF THE PREFERRED EMBODIMENTS

Exemplary embodiments of the present invention are explained in detail below with reference to the accompanying drawings.

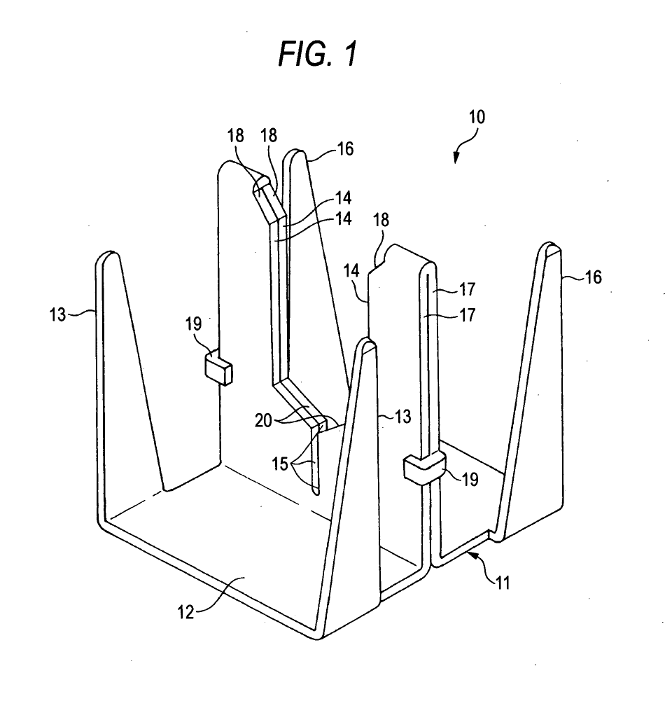

FIG. 1 is a block diagram of a communication apparatus according to a first embodiment of the present invention. The communication apparatus includes a signal-level measuring unit 2, a noise-level calculating unit 3, a signal-to-noise (S/N) ratio determining unit 4, a demodulation circuit 5, a preamble determining unit 6, a carrier sensing unit 7, a transmission/reception switching unit 8, a modulation circuit 9, and a transmission/reception controlling unit 10. The communication apparatus communicates with another communication apparatus via a transmission channel 1.

The signal-level measuring unit 2 measures a signal level of a signal with a carrier frequency on the transmission channel 1 with respect to each symbol.

The noise-level calculating unit 3 calculates an average of signal levels, which are measured by the signal-level measuring unit 2 during a period in which no communication signal is transmitted or received, as a noise level according to an instruction from the transmission/reception controlling unit 10.

The S/N ratio determining unit 4 calculates a ratio of the signal level measured by the signal-level measuring unit 2 to the noise level calculated by the noise-level calculating unit 3 (S/N ratio), and determines whether the S/N ratio exceeds a threshold.

The demodulation circuit 5 demodulates a communication signal received from the transmission channel 1 into logical data.

The preamble determining unit 6 stores therein preamble data in advance, and determines whether the logical data matches the preamble data.

If the S/N ratio determining unit 4 determines that an S/N ratio exceeds the threshold, and also if the preamble determining unit 6 determines that logical data matches the preamble data, the carrier sensing unit 7 informs the transmission/reception controlling unit 1Q that a carrier exists on the transmission channel 1.

The transmission/reception switching unit 8 switches a connection destination of the transmission channel 1 upon receipt of an instruction from the transmission/reception controlling unit 10.

The modulation circuit 9 modulates logical data, i.e., data to be transmitted, output from the transmission/reception controlling unit 10 into a communication signal, and outputs the communication signal to the transmission channel 1 via the transmission/reception switching unit 8.

The transmission/reception controlling unit 10 includes a transmission-timing controlling unit 11 and a collision detecting flag 12. The transmission-timing controlling unit 11 includes a synchronous counter 11a. The transmission-timing controlling unit 11 controls data transmission timing. The transmission/reception controlling unit 10 controls the transmission/reception switching unit 8 and the modulation circuit 9, and transmits a communication signal based on the transmission timing. Having informed by the carrier sensing unit 7 that a carrier exists on the transmission channel 1, the transmission/reception controlling unit 10 starts receiving communication signals via the demodulation circuit 5.

On completion of transmission of a communication signal, if the S/N ratio determining unit 4 determines that an S/N ratio exceeds the threshold, the transmission/reception controlling unit 10 detects whether the communication signal collides with another on the transmission channel 1. When detecting a collision of the communication signal, the transmission/reception controlling unit 10 sets the collision detecting flag 12 to “1” (If no collision is detected, the collision detecting flag 12 is set to “0”.).

When a transmission or reception of a communication signal is completed, the transmission-timing controlling unit 11 resets a count value of the synchronous counter 11a, so that the synchronous counter 11a restarts counting up from an initial value, and determines transmission timing of a communication signal based on the count value.

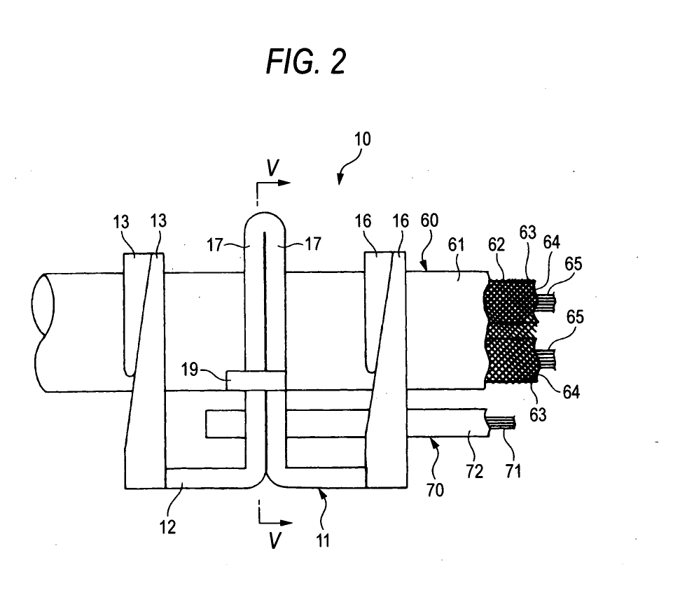

FIG. 2 is a frame format of a communication signal (a communication frame) used by the communication apparatus.

The communication frame includes a preamble 21, a synchronous code 22, a header 23, and a payload 24. The preamble 21 is data at the beginning of the communication frame that the preamble determining unit 6 compares with the preamble data. The preamble 21 is previously stored in the preamble determining unit 6 as the preamble data.

The synchronous code 22 is inserted into the communication frame to indicate a starting position of a field that contains control information for data to be processed.

The header 23 stores therein necessary information for data processing such as a length of the frame.

The payload 24 stores therein actual data to be transmitted.

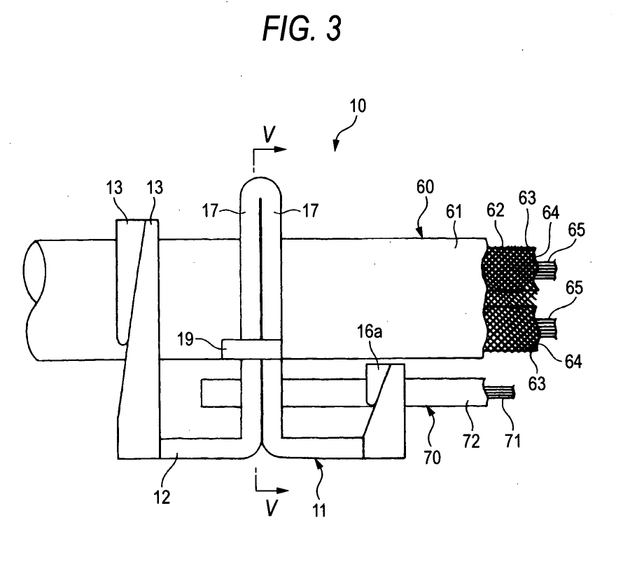

FIG. 3 is a flowchart of the operation of the communication apparatus according to the first embodiment.

According to the first embodiment, the communication apparatus employs the Differential Quadrature Phase Shift Keying (DQPSK) as a modulation scheme.

Namely, in the communication apparatus, a phase difference between a current symbol and a previous symbol ranging from −π/4 to 4/π corresponds to logical data (represented by binary numbers) “00”. A phase difference ranging from π/4 to 3π/4 corresponds to logical data “01”. A phase difference ranging from −3π/4 to −π/4 corresponds to logical data “10”. A phase difference ranging from 3π/4 to π or −π to −3π/4 corresponds to logical data “11”.

Incidentally, the preamble 21 is modulated such that it is to be demodulated to “00” (i.e., a continuous waveform with no phase shift is to be transmitted).

The transmission/reception switching unit 8 is usually connected to the receiving side, i.e., the signal-level measuring unit 2 and the demodulation circuit 5. Only when data is to be transmitted, the transmission/reception controlling unit 10 instructs the transmission/reception switching unit 8 to switch the connection to the transmitting side, i.e., the modulation circuit 9.

Therefore, if there is no request for data transmission (NO at step ST1), the signal-level measuring unit 2 and the demodulation circuit 5 are connected to the transmission channel 1 via the transmission/reception switching unit 8.

At this point, if the transmission/reception controlling unit 10 does not detect a collision of the communication frame, i.e., if the collision detecting flag 12 is “0” (NO at step ST3), the noise level is updated (step ST4) in the following manner.

The signal-level measuring unit 2 receives signals on the transmission channel 1 at each symbol interval, and measures a signal level of a signal with a carrier frequency. The symbol indicates a unit of time at which transfer data to be modulated or demodulated are switched.

Under an instruction of the transmission/reception controlling unit 10, the noise-level calculating unit 3 calculates an average of signal levels, which are measured by the signal-level measuring unit 2 during a period in which no communication frame is transmitted or received, i.e., except when the carrier sensing unit 7 senses a carrier and the transmission/reception controlling unit 10 transmits or receives a communication frame (including a demodulation of the communication frame performed by the demodulation circuit 5), as a noise level.

This averaging is performed, for example, for the latest five hundred symbols to smooth sudden changes that occasionally occur in noise. Accordingly, the carrier sensing unit 7 can be prevented from determining noise as a carrier erroneously.

The S/N ratio determining unit 4 calculates an S/N ratio, and determines whether the S/N ratio exceeds the threshold (step ST5).

If the preamble 21 in the communication frame is input from the transmission channel 1, a signal level, which is measured by the signal-level measuring unit 2, increases significantly compared to signal levels measured before. Therefore, an S/N ratio calculated by the S/N ratio determining unit 4 exceeds the threshold (Yes at step ST5).

When connected to the transmission channel 1 via the transmission/reception switching unit 8, the demodulation circuit 5 demodulates a communication signal input from the transmission channel 1 into logical data. If the preamble 21 in the communication frame is input from the transmission channel 1 to the demodulation circuit 5, the demodulation circuit 5 demodulates the preamble 21 into logical data and outputs the logical data “00” as a demodulated result to the preamble determining unit 6.

The preamble determining unit 6 determines whether the logical data matches the preamble data.

The preamble data, i.e., “preamble data=00”, is stored in the preamble determining unit 6 in advance. Therefore, when the preamble determining unit 6 receives the logical data “00”, the preamble determining unit 6 determines that the logical data matches the preamble data.

As described above, if the S/N ratio determining unit 4 determines that the S/N ratio exceeds the threshold, and also if the preamble determining unit 6 determines that the logical data matches the preamble data, the carrier sensing unit 7 determines that a carrier exists on the transmission channel 1 (YES at step ST6), and informs the transmission/reception controlling unit 10 about the presence of the carrier.

The carrier sensing unit 7 can determine the presence or absence of a carrier on the transmission channel 1 based on continuity of determination results obtained by the S/N ratio determining unit 4 and the preamble determining unit 6. That is, when the determination results satisfy a condition continuously predetermined times, a carrier is determined to be present.

By increasing the number of the predetermined times, such an event that noise is erroneously determined as a carrier can be more reliably prevented. However, it takes a long time to determine the presence or absence of a carrier; the number of the predetermined times is in a trade-off relation with a time required to reach a conclusion.

When the carrier sensing unit 7 informs the transmission/reception controlling unit 10 that a carrier exists on the transmission channel 1 (YES at step ST6), the transmission/reception controlling unit 10 starts receiving the communication frame (step ST7).

Specifically, the transmission/reception controlling unit 10 detects the synchronous code 22 from the logical data output from the demodulation circuit 5 for field synchronization, and then receives the header 23.

The header 23 has a fixed length, and contains information about a length of the payload 24 that follows the header 23. The transmission/reception controlling unit 10 receives the payload 24 based on the information contained in the header 23.

On completion of receiving the entire payload 24, the transmission/reception controlling unit 10 finishes the reception of the communication frame.

In addition, after the reception of the communication frame, the transmission-timing controlling unit 11 resets a count value of the synchronous counter 11a (step ST8).

If there is a request for data transmission (YES at step ST1), the transmission-timing controlling unit 11 calculates a transmission start time for the data based on a count value of the synchronous counter 11a.

The transmission start time is determined randomly within the range of a transmittable period, i.e., after an untransmittable period passes from a time point when a transmission or reception of a previous communication frame is completed.

The transmission start time Ts is determined within the range as follows:
Te+t1<Ts<Te+t1+t2
where Te is the time point when the transmission or reception of the previous communication frame is completed, t1 is the untransmittable period of the communication frame, and t2 is the transmittable period of the communication frame

The transmission-timing controlling unit 11 calculates the transmission start time Ts. When a count value of the synchronous counter 11a reaches the transmission start time Ts (YES at step ST2), the transmission-timing controlling unit 11 issues an instruction for data transmission to the modulation circuit 9.

If a count value of the synchronous counter 11a has not reached the transmission start time Ts (NO at step ST2), the transmission-timing controlling unit 11 waits to issue an instruction for data transmission until the count value reaches the transmission start time Ts (the process from step ST1 through steps ST2 to ST5 to ST9 and returning to step ST1 in FIG. 3).

If the carrier sensing unit 7 informs the transmission/reception controlling unit 10 that a carrier exists on the transmission channel 1 before the count value reaches the transmission start time Ts, the transmission-timing controlling unit 11 suspends the issuance of the instruction for data transmission and starts receiving a communication frame (the process from step ST2 to step ST1 in FIG. 3).

In this case, after receiving the communication frame, the transmission-timing controlling unit 11 recalculates the transmission start time Ts, and issues an instruction for data transmission when a count value reaches the transmission start time Ts.

When the transmission-timing controlling unit 11 issues the instruction for data transmission to the modulation circuit 9, the transmission/reception controlling unit 10 instructs the transmission/reception switching unit 8 to switch the connection to the transmitting side, i.e., the modulation circuit 9. Then, the transmission/reception controlling unit 10 outputs logical data to be transmitted to the modulation circuit 9.

Upon receiving the logical data from the transmission/reception controlling unit 10, the modulation circuit 9 modulates the logical data into a communication signal, and outputs the communication signal to the transmission channel 1 via the transmission/reception switching unit 8 (step ST10).

A count value of the synchronous counter 11a is incremented with respect to each symbol. When the data transmission is completed, the transmission-timing controlling unit 11 resets the count value of the synchronous counter 11a (step ST11).

After completing the transmission of all data, the transmission/reception controlling unit 10 instructs the transmission/reception switching unit 8 to switch the connection to the receiving side, i.e., to the signal-level measuring unit 2 and the demodulation circuit 5.

Besides, after the completion of the data transmission, the transmission/reception controlling unit 10 monitors determination results of the S/N ratio determining unit 4. If the S/N ratio determining unit 4 determines that an S/N ratio exceeds the threshold (YES at step ST12), the transmission/reception controlling unit 10 determines that the transmitted communication frame collides with another on the transmission channel 1, and sets the collision detecting flag 12 to “1” (step ST13).

During a period in which the collision detecting flag 12 is “1” (Yes at step ST3), the transmission/reception controlling unit 10 instructs the noise-level calculating unit 3 not to update the noise level (step ST5). When the S/N ratio determining unit 4 determines that an S/N ratio is below the threshold (NO at step ST5), the transmission/reception controlling unit 10 sets back the collision detecting flag 12 to “0” (step ST9). Then, the transmission/reception controlling unit 10 instructs the noise-level calculating unit 3 to release the suspension of updating the noise level.

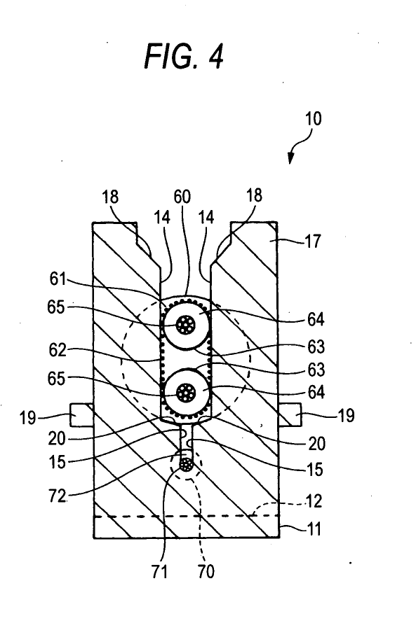

FIG. 4 is a schematic for explaining mutual communication between terminals A and B, each being the communication apparatus.

The noise level can be updated in periods 101, 103, and 106, in which both the terminals A and B neither transmit nor receive a communication frame.

In a period 102, the terminal A transmits a communication frame to the terminal B, i.e., the terminal B receives the communication frame from the terminal A.

In a period 104, both the terminals A and B accidentally transmit a communication frame simultaneously because of a coincidence of the transmission start time Ts, and a collision of the communication frames occurs.

The communication frame transmitted from the terminal A is shorter than that from the terminal B (see FIG. 4). Therefore, the terminal A completes the transmission earlier than the terminal B.

In a period 105, the terminal B has not yet completed the transmission. Therefore, in the terminal A, an S/N ratio that is checked after the transmission exceeds the threshold.

Thus, the terminal A suspends the update of the noise level in the period 105. When an S/N ratio drops below the threshold in the period 106, the terminal A restarts updating the noise level. On the other hand, the terminal B restarts updating the noise level immediately after the completion of the transmission in the period 106 because an S/N ratio is below the threshold.

As described above, according to the first embodiment, if the S/N ratio determining unit 4 determines that an S/N ratio exceeds the threshold, and also if the preamble determining unit 6 determines that logical data matches the preamble data, reception of a communication frame is started. In other words, only when a carrier is surely present, the communication apparatus starts receiving a communication frame. Thus, a decrease in data throughput can be effectively prevented.

Moreover, the noise-level calculating unit 3 calculates an average of signal levels, which are measured by the signal-level measuring unit 2 during a period in which no communication signal is transmitted or received, as the noise level. After the transmission of the communication frame, an S/N ratio is monitored. If the S/N ratio exceeds the threshold, it is determined that the communication frame collides with another frame on the transmission channel 1, and the update of the noise level is suspended until the S/N ratio drops below the threshold. Thus, it is possible to prevent a temporary increase in noise level due to a signal level of a communication frame that is erroneously counted in the averaging process when a collision of communication frames occurs.

If the noise level erroneously increases, the presence of a carrier cannot be detected accurately until the noise level becomes a proper value. Therefore, the communication reliability and data throughput may decrease.

In the communication apparatus according to the first embodiment, when a count value of the synchronous counter 11a reaches the transmission start time Ts, the transmission-timing controlling unit 11 immediately issues an instruction for data transmission to the modulation circuit 9. In a communication apparatus according to a second embodiment, the transmission-timing controlling unit 11 does not immediately issue the instruction for data transmission even when the count value of the synchronous counter 11a reaches the transmission start time Ts. The transmission/reception controlling unit 10 checks the collision detecting flag 12, and if the collision detecting flag 12 is “1”, the transmission/reception controlling unit 10 rejects to start transmitting a new communication frame until the S/N ratio drops below the threshold.

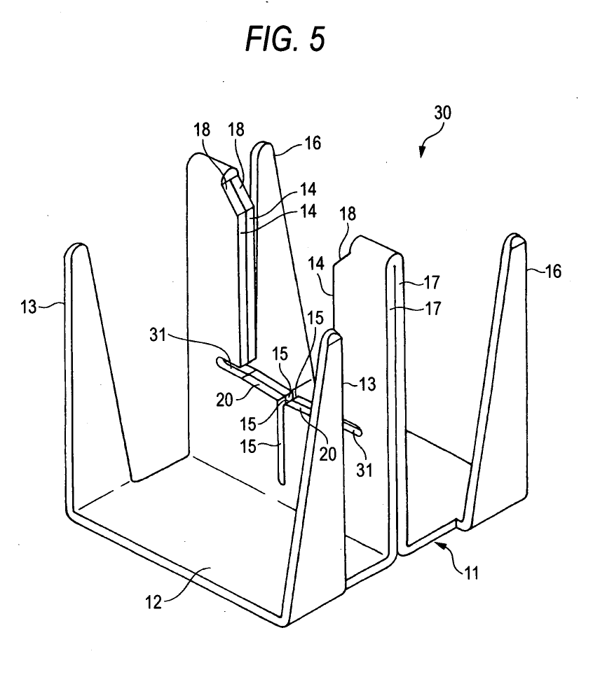

FIG. 5 is a flowchart of the operation of the communication apparatus according to the second embodiment.

When there is a request for data transmission (step ST1), the transmission-timing controlling unit 11 calculates a transmission start time Ts in the same manner as in the first embodiment.

When a count value of the synchronous counter 11a reaches the transmission start time Ts (YES at step ST2), the transmission-timing controlling unit 11 checks the collision detecting flag 12 (step ST14).

If the collision detecting flag 12 is “0” (NO at step ST14), the transmission-timing controlling unit 11 determines that no communication frame collides on the transmission channel 1. Therefore, the transmission-timing controlling unit 11 issues an instruction for data transmission to the modulation circuit 9 in the same manner as in the first embodiment. Then, data is transmitted in the same manner as in the first embodiment (step ST10).

If the collision detecting flag 12 is “1” (YES at step ST14), the transmission-timing controlling unit 11 determines that communication frames collide on the transmission channel 1. The transmission-timing controlling unit 11 monitors whether an S/N ratio calculated by the S/N ratio determining unit 4 exceeds the threshold (step ST5).

If the S/N ratio exceeds the threshold (YES step ST5), the transmission-timing controlling unit 11 does not issue an instruction for data transmission. If the S/N ratio is below the threshold (NO step ST5), the transmission-timing controlling unit 11 sets back the collision detecting flag 12 to “0” (step ST9). Then, the transmission-timing controlling unit 11 issues the instruction for data transmission to the modulation circuit 9, and performs data transmission (the process from step ST5 through steps ST9, ST1, ST2, and ST14 to step ST10 in FIG. 5).

As described above, according to the second embodiment, even when a count value of the synchronous counter 11a reaches the transmission start time Ts, the transmission-timing controlling unit 11 does not immediately issue an instruction for data transmission. The transmission/reception controlling unit 10 checks the collision detecting flag 12. If the collision detecting flag 12 is “1”, the transmission/reception controlling unit 10 rejects to start transmitting a communication frame until an S/N ratio drops below the threshold. Therefore, the transmission of a new communication frame is not started during a period in which another communication apparatus is transmitting a communication frame. Thus, it is possible to prevent a decrease in communication reliability and data throughput due to a collision of communication frames.

In the communication apparatus according to the first and second embodiments, when the carrier sensing unit 7 informs the transmission/reception controlling unit 10 that a carrier exists on the transmission channel 1, the transmission/reception controlling unit 10 immediately starts receiving a communication frame. In a communication apparatus according to a third embodiment, even when informed by the carrier sensing unit 7 that a carrier exists on the transmission channel 1, the transmission/reception controlling unit 10 does not start receiving a communication frame immediately. The transmission/reception controlling unit 10 checks the collision-detecting flag 12. If the collision detecting flag 12 is “1”, the transmission/reception controlling unit 10 rejects to start receiving a communication frame until an S/N ratio drops below the threshold.

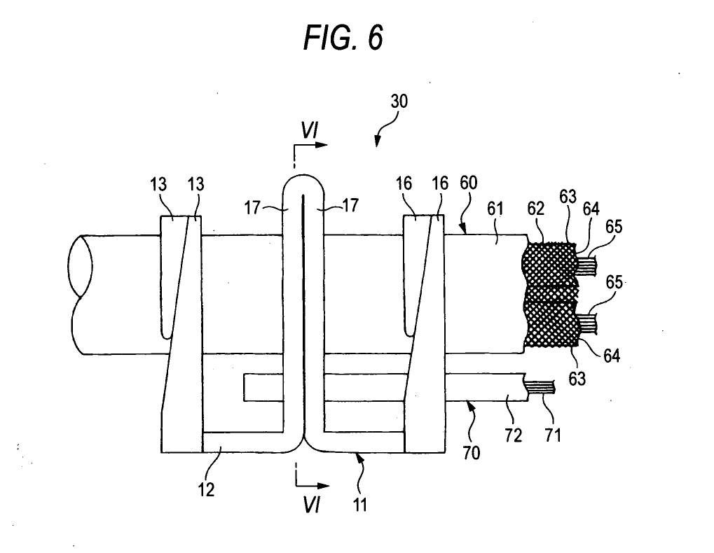

FIG. 6 is a flowchart of the operation of the communication apparatus according to the third embodiment.

In the same manner as in the first and second embodiments, if the S/N ratio determining unit 4 determines that an S/N ratio exceeds the threshold, and also if the preamble determining unit 6 determines that logical data matches the preamble data, the carrier sensing unit 7 determines that a carrier exists on the transmission channel 1 (YES at step ST6), and informs the transmission/reception controlling unit 10 about the presence of the carrier.

When informed by the carrier sensing unit 7 that the carrier exists on the transmission channel 1, the transmission/reception controlling unit 10 checks the collision detecting flag 12 (step ST15).

If the collision detecting flag 12 is “0” (NO at step ST15), the transmission/reception controlling unit 10 determines that no communication frame collides on the transmission channel 1. Therefore, the transmission/reception controlling unit 10 starts receiving the communication frame via the demodulation circuit 5 (step ST7) in the same manner as in the first and second embodiments.

If the collision detecting flag 12 is “1” (YES at step ST15), the transmission/reception controlling unit 10 determines that communication frames collide on the transmission channel 1. Until the S/N ratio drops below the threshold (NO at step S5) and the collision detecting flag 12 is set back to “0” (step ST9), the transmission/reception controlling unit 10 does not start receiving the communication frame.

As described above, according to the third embodiment, even when informed by the carrier sensing unit 7 that a carrier exists on the transmission channel 1, the transmission/reception controlling unit 10 does not start receiving a communication frame immediately. The transmission/reception controlling unit 10 checks the collision detecting flag 12. If the collision detecting flag 12 is “1”, the transmission/reception controlling unit 10 rejects to start receiving the communication frame until an S/N ratio drops below the threshold. Therefore, even if a modulation pattern of a preamble appears accidentally in a collided communication frame and conditions for carrier sense are satisfied, reception of the communication frame can be prevented from being erroneously started.

When the communication apparatus once starts receiving the communication frame, it takes a time to finish receiving the communication frame. If a sender communication apparatus completes the transmission of the communication frame during the time, the communication apparatus may not transmit a communication frame at the right timing next time.

In the communication apparatus according to the first to third embodiments, when transmission or reception of a communication frame is completed, the transmission-timing controlling unit 11 resets a count value of the synchronous counter 11a. In a communication apparatus according to a fourth embodiment, if an S/N ratio is below the threshold, and also if the collision detecting flag 12 is “1”, the transmission-timing controlling unit 11 resets a count value of the synchronous counter 11a.

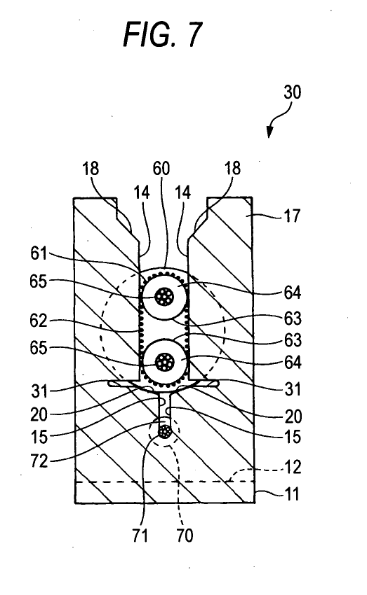

FIG. 7 is a flowchart of the operation of the communication apparatus according to the fourth embodiment.

The S/N ratio determining unit 4 calculates an S/N ratio in the same manner as in the first to third embodiments. Then, the S/N ratio determining unit 4 determines whether the S/N ratio exceeds the threshold (step ST5).

If the S/N ratio exceeds the threshold (YES at step ST5), the carrier sensing unit 7 determines whether a carrier exists on the transmission channel 1 (step ST6) in the same manner as in the first to third embodiments. If the S/N ratio is below the threshold (NO at step ST5), the transmission-timing controlling unit 11 checks the collision detecting flag (step ST16).

Even if the collision detecting flag 12 is “1” (YES at step ST16), i.e., a collision of a communication frame was detected after the communication frame was previously transmitted, the S/N ratio has already dropped below the threshold and also the collision has already been resolved. Therefore, the transmission-timing controlling unit 11 resets a count value of the synchronous counter 11a (step ST17), and sets back the collision detecting flag 12 to “0” (step ST9).

As described above, according to the fourth embodiment, when a collision of a communication frame is detected on the transmission channel 1, the transmission-timing controlling unit 11 resets a count value of the synchronous counter 11a at a time point when an S/N ratio drops below the threshold. Therefore, the count value of the synchronous counter 11a can be synchronized with that of other communication apparatuses connected to the transmission channel 1. Thus, the frame synchronization can be maintained.

If the frame synchronization is disrupted, the communication apparatus may transmit a communication frame at the wrong timing. Moreover, communication apparatuses may not have a transmitting turn equally.

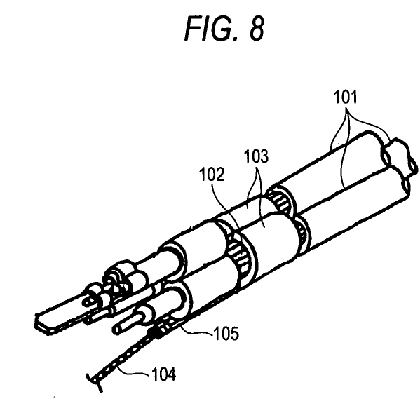

FIG. 8 is a block diagram of a communication apparatus according to a fifth embodiment. The communication apparatus according to the fifth embodiment is essentially similar to that shown in FIG. 1 except for the presence of a transmission/reception controlling unit 20 in place of the transmission/reception controlling unit 10. The transmission/reception controlling unit 20 further includes a collision time-out counter 13. The portions identical to those in FIG. 1 are denoted with the same reference numerals and the description of those portions is omitted.

When the transmission/reception controlling unit 20 detects a collision of communication frames on the transmission channel 1, the collision time-out counter 13 is activated. If an S/N ratio does not drop below the threshold before a time-out of the collision time-out counter 13, the transmission/reception controlling unit 20 sets back the collision detecting flag 12 to “0” at the time-out of the collision time-out counter 13.

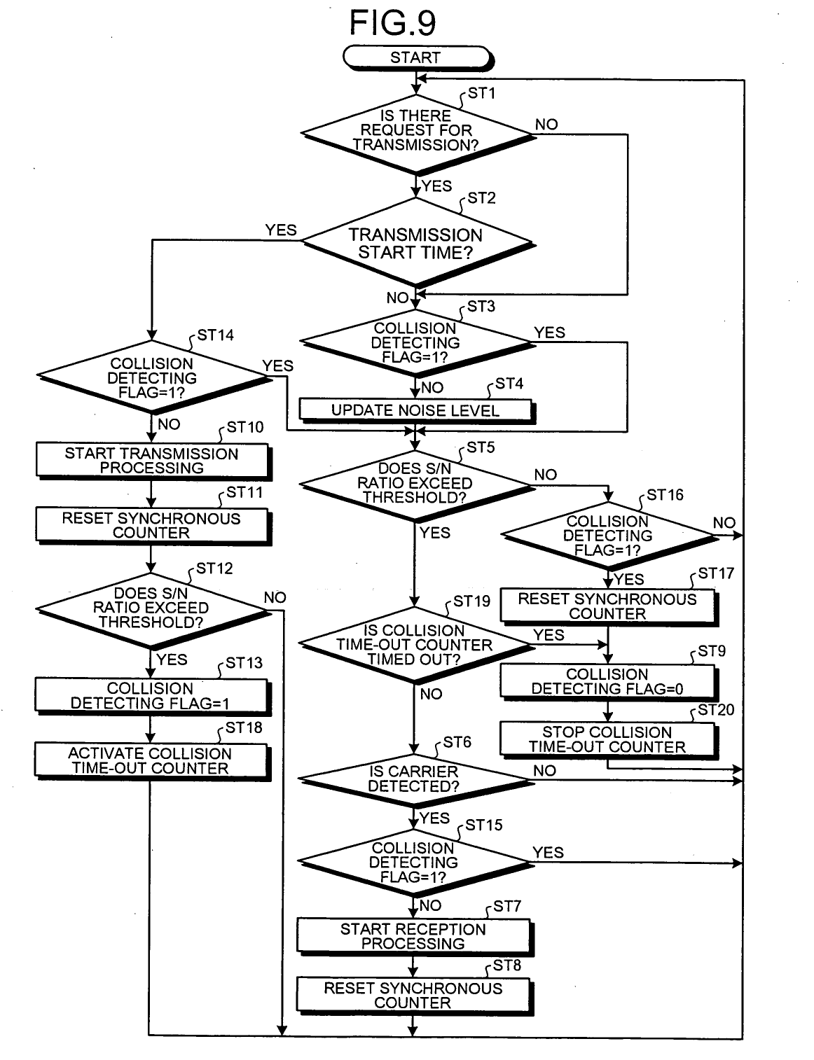

FIG. 9 is a flowchart of the operation of the communication apparatus according to the fifth embodiment.

After a transmission of a communication frame is completed, the transmission/reception controlling unit 20 monitors whether an S/N ratio calculated by the S/N ratio determining unit 4 exceeds the threshold. If the S/N ratio exceeds the threshold (YES at step ST12), the transmission/reception controlling unit 20 determines that the transmitted communication frame collides with another on the transmission channel 1, and sets the collision detecting flag 12 to “1” (step ST13). Then, the transmission/reception controlling unit 20 activates the collision time-out counter 13 (step ST18).

Incidentally, a time-out period of the collision time-out counter 13 is set, for example, based on a maximum length of a communication frame.

The transmission/reception controlling unit 20 monitors whether an S/N ratio calculated by the S/N ratio determining unit 4 drops below the threshold. If the S/N ratio still exceeds the threshold (YES at step ST5) at the time-out of the collision time-out counter 13 (YES at step ST19), the transmission/reception controlling unit 20 sets back the collision detecting flag 12 to “0” (step ST9), and stops the collision time-out counter 13 (step ST20).

As described above, according to the fifth embodiment, when a collision of communication frames is detected, the collision time-out counter 13 is activated. If an S/N ratio calculated by the S/N ratio determining unit 4 still exceeds the threshold at the time-out of the collision time-out counter 13, the collision detecting flag 12 is set back to “0” at the time-out of the collision time-out counter 13. Therefore, even if the noise level on the transmission channel 1 accidentally increases during transmission of a communication frame, the communication apparatus is to be recovered to a usual state after a predetermined period of time. Thus, it is possible to prevent an erroneous detection of a collision and also to suppress a decrease in communication reliability and data throughput at the time of the collision.

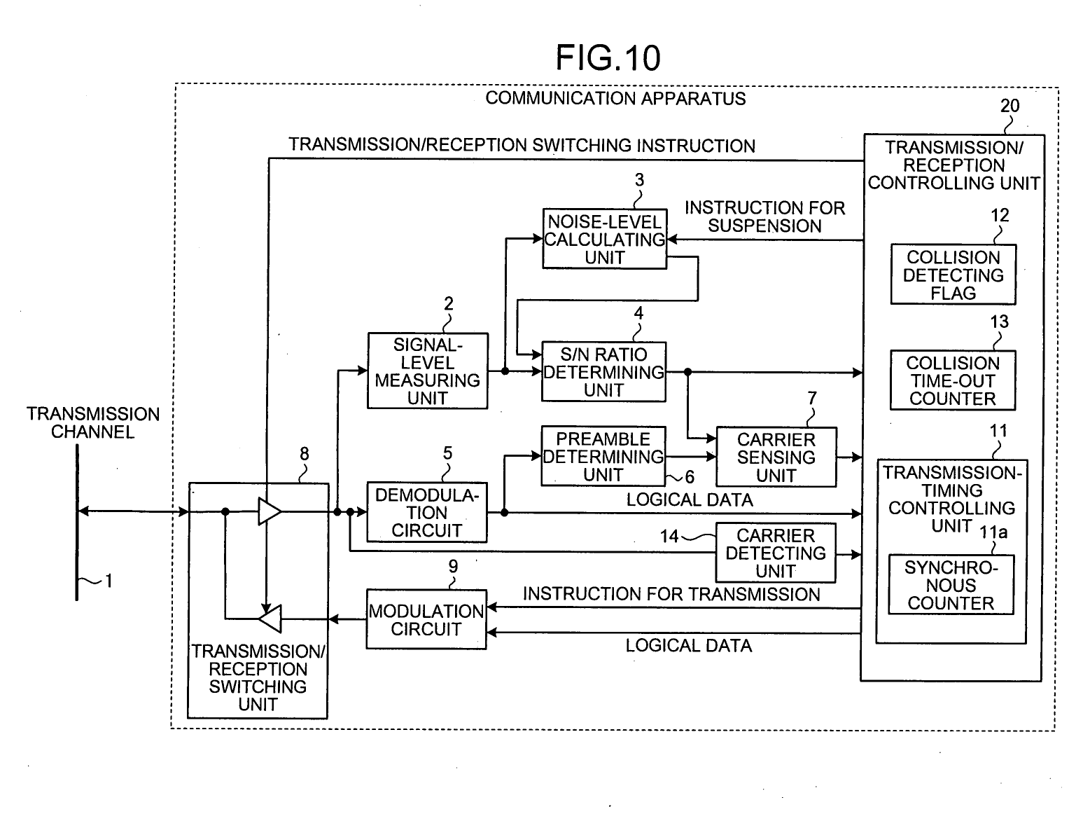

FIG. 10 is a block diagram of a communication apparatus according to a sixth embodiment. The communication apparatus according to the sixth embodiment is essentially similar to that shown in FIG. 8 except for the presence a carrier determining unit 14. The portions identical to those in FIG. 8 are denoted with the same reference numerals and the description thereof is omitted.

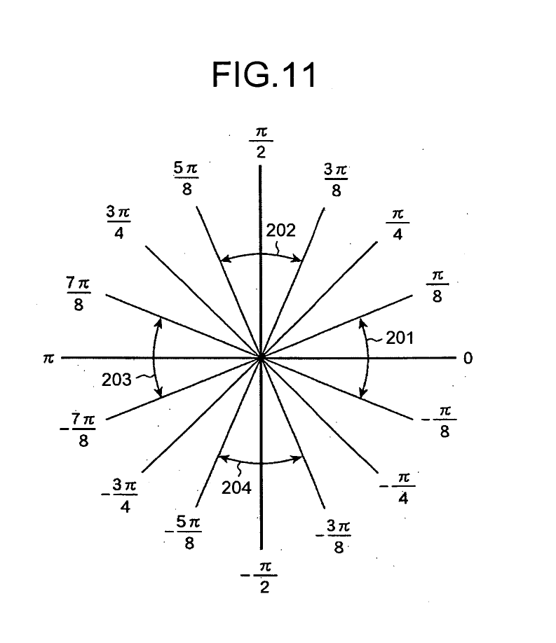

The carrier determining unit 14 determines whether a phase difference between a current symbol and a previous symbol in a communication packet on the transmission channel 1 is in any one of ranges 201 to 204 (see FIG. 11) narrower than a predetermined range. If the phase difference is not in any one of the ranges 201 to 204, the carrier determining unit 14 informs the transmission/reception controlling unit 20 that no carrier exists on the transmission channel 1.

The transmission/reception controlling unit 20 according to the sixth embodiment has the following function in addition to the same functions as previously described in the first to fifth embodiments.

Even when an S/N ratio calculated by the S/N ratio determining unit 4 exceeds the threshold, if informed by the carrier determining unit 14 that no carrier exists on the transmission channel 1, the transmission/reception controlling unit 20 does not detect a collision of communication frames on the transmission channel 1.

FIG. 11 is a schematic for explaining a range of a phase difference between a current symbol and a previous symbol to determine whether a carrier exists on the transmission channel 1.

In the example of FIG. 11, the range is narrowed down to a half of a range in which logical data is allocated at the time of demodulation.

In the DQPSK, the transmitting side performs transmission with a phase difference of π/2. When a communication frame is input, the phase difference between the current symbol and the previous symbol is likely to be in any one of the ranges 201 to 204.

Therefore, if the phase difference is in any one of the ranges 201 to 204, the carrier determining unit 14 determines that a carrier exists on the transmission channel 1. However, if the phase difference is not in any one of the ranges 201 to 204, the carrier determining unit 14 determines that no carrier exists on the transmission channel 1.

By narrowing down the ranges, there is less probability that a noise is erroneously determined as a carrier. However, there is more probability that a carrier is not detected due to an influence of a noise.

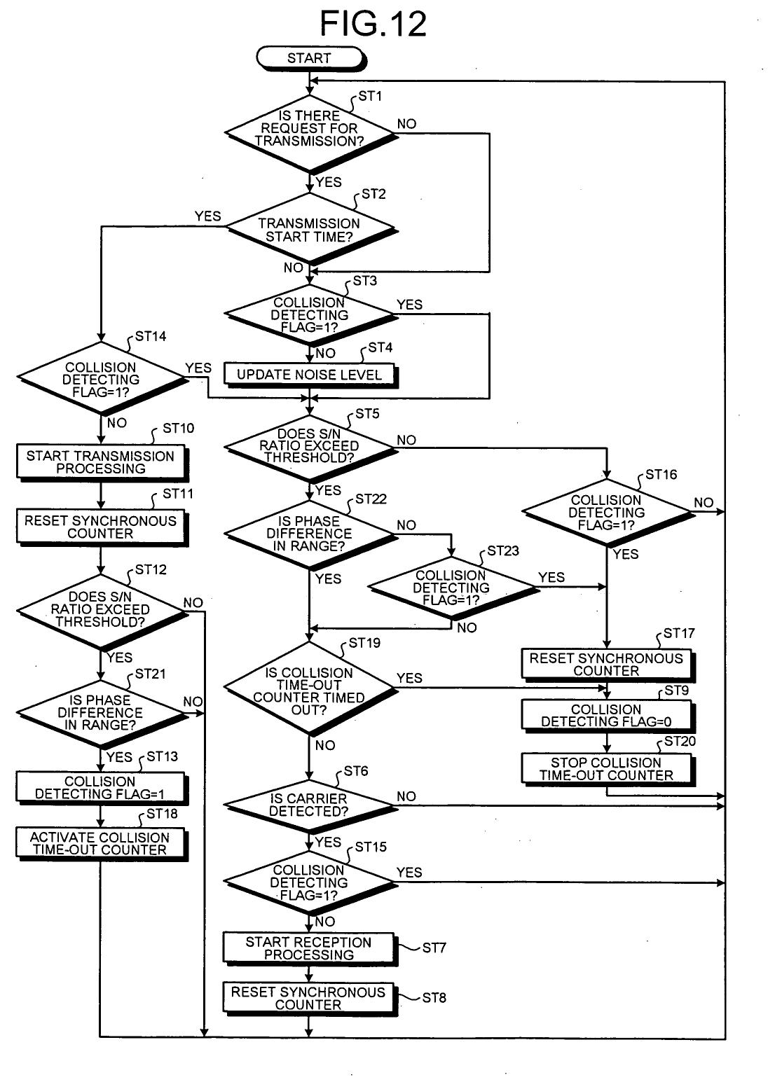

FIG. 12 is a flowchart of the operation of the communication apparatus according to the sixth embodiment.

After completion of a data transmission, the transmission/reception controlling unit 20 determines whether an S/N ratio exceeds the threshold (step ST12) by monitoring a calculation result of the S/N ratio determining unit 4.

If the S/N ratio exceeds the threshold (YES at step ST12), the carrier determining unit 14 determines whether a phase difference between a current symbol and a previous symbol is in any one of the ranges 201 to 204 (step ST21). If the phase difference is in any one of the ranges 201 to 204 (YES at step ST21), the carrier determining unit 14 informs the transmission/reception controlling unit 20 that a carrier exists on the transmission channel 1.

Having been informed by the carrier determining unit 14 that a carrier exists on the transmission channel 1, if the S/N ratio exceeds the threshold, the transmission/reception controlling unit 20 determines that a communication frame, which was previously transmitted to the transmission channel 1, collides with another frame on the transmission channel 1. Then, the transmission/reception controlling unit 20 sets the collision detecting flag 12 to “1” (step ST13), and activates the collision time-out counter 13 (step ST18).

The transmission/reception controlling unit 20 monitors determination results of the S/N ratio determining unit 4 and the carrier determining unit 14. If the S/N ratio determining unit 4 determines that an S/N ratio exceeds the threshold (YES at step ST5), and also if the carrier determining unit 14 determines that a phase difference between a current symbol and a previous symbol is not in any one of the ranges 201 to 204 (NO at step ST22), the transmission/reception controlling unit 20 determines whether the collision detecting flag 12 is “1” (step ST23).

If the collision detecting flag 12 is “1” (YES at step ST23), the transmission/reception controlling unit 20 resets the synchronous counter 11a (step ST17), and sets back the collision detecting flag 12 to “0” (step ST9), and stops the collision time-out counter 13 (step ST20) in the same manner as in the fifth embodiment.

If the carrier determining unit 14 determines that a phase difference between a current symbol and a previous symbol is in any one of the ranges 201 to 204 (YES at step ST22), the transmission/reception controlling unit 20 determines whether the collision time-out counter 13 is timed out (step ST19).

All remaining steps are the same as previously described in connection with FIG. 9 for the fifth embodiment, and the same description is not repeated.

As described above, according to the sixth embodiment, even if the S/N ratio determining unit 4 determines that an S/N ratio exceeds the threshold, it is determined that no carrier exists on the transmission channel 1 if a phase difference between a current symbol and a previous symbol in a communication packet on the transmission channel 1 is not in any one of the ranges 201 to 204, which are narrower than the predetermined range. Therefore, the communication apparatus according to the sixth embodiment can detect a collision of communication frames more accurately than those of the first to fifth embodiments. Thus, it is possible to prevent a decrease in communication reliability and data throughput at the time of the collision.

In the sixth embodiment, if a phase difference between a current symbol and a previous symbol is in any one of the ranges 201 to 204, the carrier determining unit 14 determines that a carrier exists on the transmission channel 1. Meanwhile, if the phase difference is not in any one of the ranges 201 to 204, the carrier determining unit 14 determines that no carrier exists on the transmission channel 1. However, in the absolute phase modulation/demodulation system, if a phase of a current symbol is in any one of the ranges 201 to 204, it can be determined that a carrier exists on the transmission channel 1. If the phase is not in any one of the ranges 201 to 204, it can be determined that no carrier exists on the transmission channel 1.

In addition, depending on the modulation/demodulation system being employed, the carrier determining unit 14 can determine whether a carrier exists on the transmission channel 1, for example, based on an amplitude difference between a current symbol and a previous symbol in a communication signal, or whether amplitude of the current symbol is within a predetermined range.

As set forth hereinabove, according to an embodiment of the present invention, if the signal-to-noise ratio determining unit determines that a ratio of a signal level to a noise level exceeds the threshold, and also if the preamble determining unit determines that logical data matches the preamble data, the communication apparatus starts receiving a communication signal. Namely, only when a carrier surely exists on the transmission channel, the communication apparatus starts receiving the communication signal. Thus, it is possible to prevent a decrease in data throughput.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication apparatus comprising:
a signal-level measuring unit that periodically measures a signal level of a communication signal on a transmission channel;
a noise-level calculating unit that calculates, as a noise level, an average of signal levels measured by the signal-level measuring unit during a period in which no communication signal is communicated;
a signal-to-noise ratio determining unit that calculates a ratio of each of the signal levels to the noise level to obtain a signal-to-noise ratio corresponding to each of the signal levels, and determines whether the signal-to-noise ratio exceeds a threshold;
a preamble determining unit that demodulates the communication signal from the transmission channel into logical data, and determines whether the logical data matches preamble data; and
a reception processing unit that starts receiving the communication signal when the signal-to-noise ratio exceeds the threshold, and the logical data matches the preamble data.

2. The communication apparatus according to claim 1, further comprising a collision detecting unit that detects, when the signal-to-noise ratio exceeds the threshold after transmission of a communication signal is completed, whether the communication signal collides with another signal on the transmission channel.

3. The communication apparatus according to claim 2, wherein when the collision detecting unit detects a collision of communication signals on the transmission channel, the noise-level calculating unit stops calculating the noise level until the signal-to-noise ratio drops below the threshold.

4. The communication apparatus according to claim 2, wherein when the collision detecting unit detects a collision of communication signals on the transmission channel, no communication signal is newly transmitted until the signal-to-noise ratio drops below the threshold.

5. The communication apparatus according to claim 2, wherein even if the signal-to-noise ratio exceeds the threshold, and the logical data matches the preamble data, when the collision detecting unit detects a collision of communication signals on the transmission channel, the reception processing unit receives no newly transmitted communication signal until the signal-to-noise ratio drops below the threshold.

6. The communication apparatus according to claim 2, further comprising a transmission controlling unit that determines timing of transmitting a communication signal based on a count value that is reset on completion of any one of transmission and reception of a communication signal and then counted up, wherein
when the collision detecting unit detects a collision of communication signals on the transmission channel, the transmission controlling unit resets the count value at a time point when the signal-to-noise ratio drops below the threshold.

7. The communication apparatus according to claim 3, wherein after detecting a collision of communication signals on the transmission channel, when the signal-to-noise ratio still exceeds the threshold after a predetermined time, the collision detecting unit cancels detected collision.

8. The communication apparatus according to claim 4, wherein after detecting a collision of communication signals on the transmission channel, when the signal-to-noise ratio still exceeds the threshold after a predetermined time, the collision detecting unit cancels detected collision.

9. The communication apparatus according to claim 5, wherein after detecting a collision of communication signals on the transmission channel, when the signal-to-noise ratio still exceeds the threshold after a predetermined time, the collision detecting unit cancels detected collision.

10. The communication apparatus according to claim 6, wherein after detecting a collision of communication signals on the transmission channel, when the signal-to-noise ratio still exceeds the threshold after a predetermined time, the collision detecting unit cancels detected collision.

11. The communication apparatus according to claim 2, wherein even when the signal-to-noise ratio exceeds the threshold, the collision detecting unit does not detect a collision of communication signals on the transmission channel if the communication signal on the transmission channel is not in a range narrower than a predetermined range.
